(19) United States
(12) Patent Application Publication
(10) Pub. No.: US 2002/0166233 A1
(43) Pub. Date: Nov. 14, 2002

(54) Process for making and assembling a heat exchanger core and housing

(75) Inventor: Thomas Uchison, Forest Park, IL (US)

Correspondence Address: JONES, DAY, REAVIS AND POGUE, 35TH FLOOR, 77 WEST WACKER, CHICAGO, IL, 60601-1692, US

(73) Assignee: Marconi Communications, Inc., Cleveland, OH

(21) Appl. No.: 09/852,559

(22) Filed: May 10, 2001

(51) Int. Cl. B23P 15/26

(52) U.S. Cl. 29/890.039

(57) ABSTRACT

A process for economically forming and assembling heat exchangers is disclosed. The process begins with a roll of synthetic resin which is heated and then impressed with a series of alternating panels and hinges. The hinges are formed so as to provide for an accordion fold. The formed strip of material is then cooled, trimmed, measured and cut. Thereafter, the strip of material is folded in an accordion fashion. The folded core may be bonded or constrained so as to form two sets of fluid flow passages in an alternating manner. Depending upon the design of the panels formed in the strip of material, the cores will either be counterflow or cross flow. In addition, a housing is thermo formed and then assembled with the core to complete the heat exchanger.

### BACKGROUND OF THE INVENTION

1. Field of the Invention

The present invention relates to a process for making a heat exchanger core and assembling the core in a housing, and more particularly, to a continuous and low cost process for manufacturing and assembling heat exchanger cores and heat exchangers.

2. Description of the Related Art

Heat exchangers are used to manage heat in such items as electronic equipment enclosures used in the transmission of data. Heat exchangers may also find use in energy recovery ventilators and elsewhere. Examples of heat exchangers are disclosed in the following patents and applications: U.S. Pat. Nos. 6,119,768; 4,997,031; 4,907,648; 4,874,035; 4,858,685; 4,820,468; 4,738,311; GB 2158569; PCT SE 82/00393; and GB 98/03368.

A constant objective is to build such heat exchangers in the most economical manner as possible.

### BRIEF SUMMARY OF THE INVENTION

The present invention is a process for forming a heat exchanger core comprising the steps of providing a strip of material, forming in said material a repeated pattern of panels separated by integral hinges, cutting the strip of material to a predetermined length, and folding the strip of material at the hinges in an accordion-like fashion. After forming the core, the core may be placed in a thermoformed housing to complete a heat exchanger.

There are a number of advantages, features and objects achieved with the present invention which are believed not to be available in earlier related processes. For example, one advantage is that the present invention provides a continuous, automated process resulting in a low cost, easily assembled heat exchanger core. Another feature of the present invention is to provide a process which is simple and yet reliable. Yet another object of the present invention is to provide a process for producing heat exchangers which are economical to make and assemble.

A more complete understanding of the present invention and other objects, advantages and features thereof will be gained from a consideration of the following description of the preferred embodiments read in conjunction with the accompanying drawing provided herein.

### BRIEF DESCRIPTION OF THE SEVERAL VIEWS OF THE DRAWING

FIG. 1 is a plan view of a partial flat strip of synthetic resin material formed as disclosed herein.

FIG. 2 is an enlarged broken sectional view taken along line 2-2 of FIG. 1.

FIG. 3 is an enlarged broken sectional view taken along line 3-3 of FIG. 1.

FIG. 4 is an enlarged broken sectional view taken along line 4-4 of FIG. 1.

FIG. 5 is a front isometric view of a partially folded heat exchanger core made from the flat strip of material illustrated in FIG. 1 according to the present invention.

FIG. 6 is a rear isometric view of the partially folded heat exchanger core shown in FIG. 5.

FIG. 7 is a downward looking isometric view of the heat exchanger core shown in FIGS. 5 and 6, but in a fully folded position.

FIG. 8 is an exploded isometric view of a heat exchanger including the core shown in FIG. 7.

FIG. 9 is a plan view of another embodiment of a partial flat strip of synthetic resin material formed as disclosed herein.

FIG. 10 is a sectional view taken along line 10-10 of FIG. 9.

FIG. 11 is a sectional view taken along line 11-11 of FIG. 9.

FIG. 12 is a sectional view taken along line 12-12 of FIG. 9.

FIG. 13 is an enlarged view taken within the circle 13-13 of FIG. 11.

FIG. 14 is an enlarged view taken within the circle 14-14 of FIG. 11.

FIG. 15 is a right side, downward looking isometric view of a partially folded heat exchanger core shown in FIGS. 9-14 and made by the process of the present invention.

FIG. 16 is an enlarged left side, downward looking isometric view of the heat exchanger core shown in FIG. 15.

FIG. 17 is an enlarged view of a portion of the heat exchanger core taken within the circle 17-17 of FIG. 16.

FIG. 18 is an enlarged view of the heat exchanger core taken within the circle 18-18 of FIG. 15.

FIG. 19 is an isometric view of another embodiment of a heat exchanger with the core illustrated in FIGS. 9-18.

FIG. 20 is a diagrammatic isometric view of a process for manufacturing the heat exchanger cores of the present invention.

FIG. 21 is a diagrammatic isometric view of a folding and bonding station shown in FIG. 20.

### DETAILED DESCRIPTION OF THE INVENTION

While the present invention is open to various modifications and alternative constructions, the preferred embodiments shown in the drawing will be described herein in detail. It is understood, however, that there is no intention to limit the invention to the particular forms or processes disclosed. On the contrary, the intention is to cover all modifications, equivalent structures and processes, and alternative constructions falling within the spirit and scope of the invention as expressed in the appended claims.

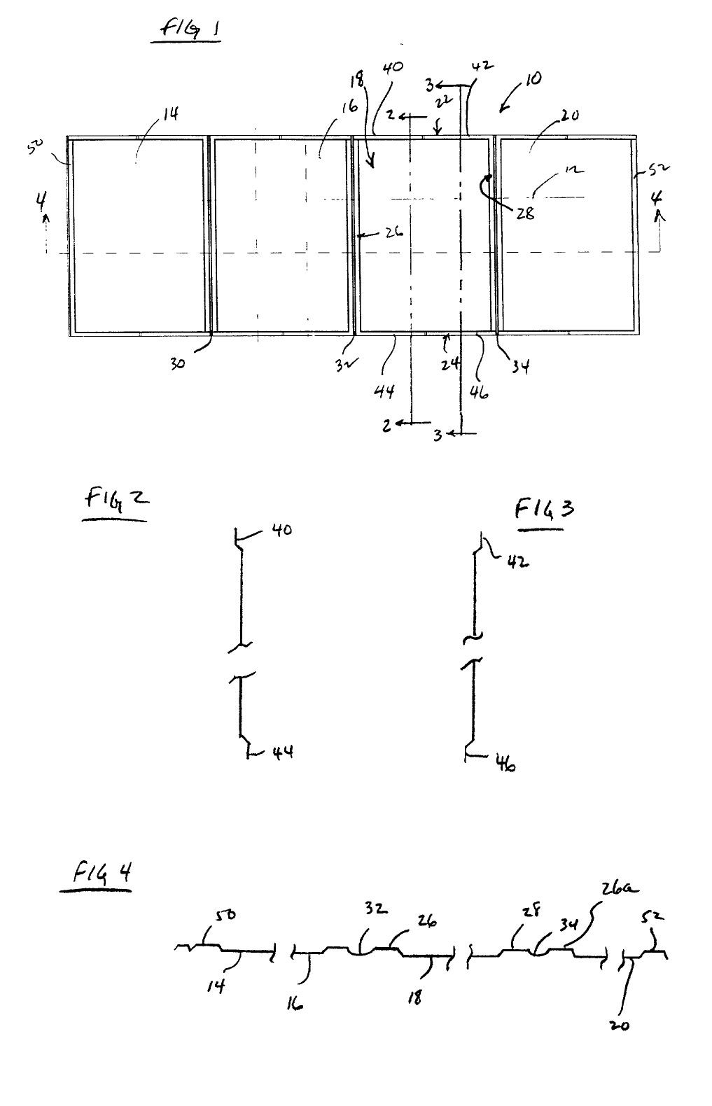

The simplicity and economical features of the present invention are apparent by referring to FIGS. 1-4. There is illustrated a portion of a formed elongated strip 10 of synthetic resin material. For purposes of orientation, a longitudinal axis 12 for the strip is illustrated in phantom line. The elongated strip portion is shown divided into four panels 14, 16, 18, 20 with each panel having opposed longitudinal sides and opposed latitudinal sides, such as the longitudinal sides 22, 24 of the panel 18 and the latitudinal sides 26, 28 of the same panel. Each panel has two longitudinal and two latitudinal sides. It is further to be understood that while only four panels are illustrated, the elongated strip will usually contain far more panels as will be explained hereinbelow. Between adjacent panels is an integral hinge, such as the hinge 30 between the panels 14 and 16, the hinge 32 between the panels 16 and 18 and the hinge 34 between the panels 18 and 20. Also, as will be shown in detail below, the hinges are made to fold in alternate directions to achieve an accordion like disposition when the strip is folded at the hinges during assembly.

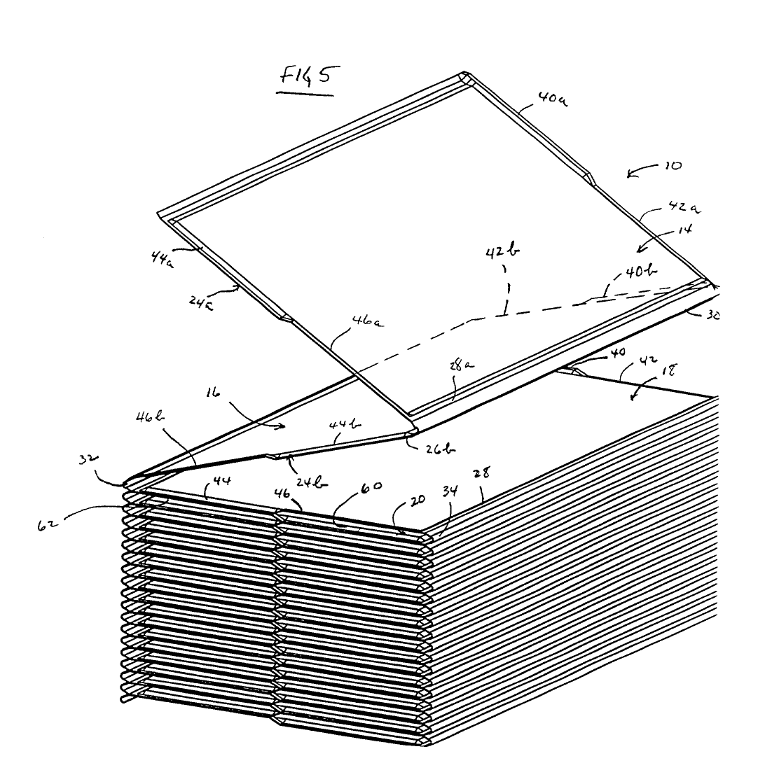

The longitudinal sides 22, 24 are each divided into first and second generally equal portions. For example, the longitudinal side 22 includes a first portion 40 and a second portion 42. In a like manner, the longitudinal side 24 includes a first portion 44 and a second portion 46. As shown more clearly in FIGS. 2 and 3, each portion of the longitudinal sides includes a bent border but in an alternating fashion. For example, the longitudinal side portion 40 has a downward or closed bend whereas the longitudinal side portion 42 has an upward or open bend. The opposite longitudinal side portions of a panel are bent in opposing directions. For example, the longitudinal side portion 44 is bent upwardly or in an open position whereas the longitudinal side portion 46 is bent downwardly or in a closed position. The concept of opened and closed portions will also be explained in more detail below. Each of the latitudinal sides, such as the sides 26, 28 has a raised border which will act as a spacer to separate the adjacent panels when the strip is folded. The latitudinal sides of each panel are integrally formed adjacent a hinge except for the end latitudinal sides 50, 52 of the end panels 14, 20, respectively of the strip.

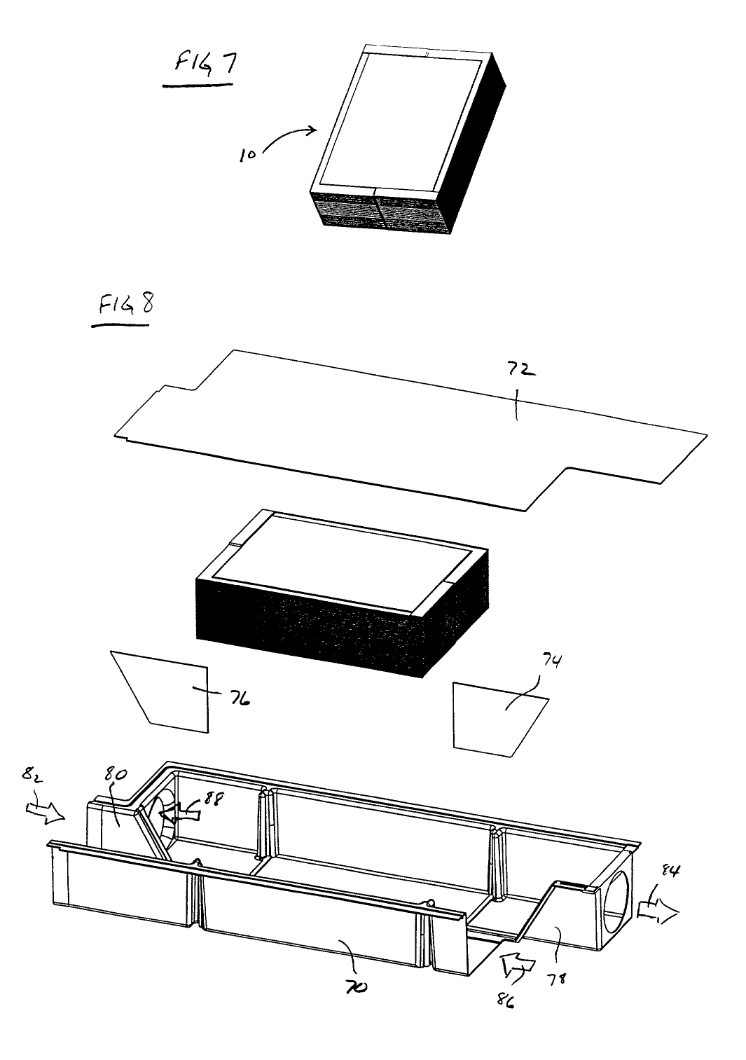

Referring now to FIGS. 5 and 6, the elongated strip 10 is shown enlarged and in a partially folded position where the folded hinges bend in alternate directions, accordion-like. It can now be appreciated that the longitudinal side portions alternately provide openings to form first and second sets of fluid flow passages through the folded stack of panels, the fluid flow passages being generally parallel to the latitudinal sides of the panels. For example, the first portion 44a of the longitudinal side 24a of the panel 14 is bent downwardly to meet the upwardly slanting second portion 46b of the longitudinal side 24b of the panel 16. When these side portions come together, a closure is formed against fluid flow entering or leaving through the left side portion of the space between the panels 14, 16 as viewed in FIG. 5. The right side portion of the space, however, formed by the side portion 46a and the side portion 44b are bent upwardly so as to provide an opening to fluid flow on the right side between the panels 14 and 16. On the opposite longitudinal side of the panel, the edge portions 40a and 42b are bent upwardly to form an opening whereas the edge portions 42a and 40b are bent downwardly to form a closure.

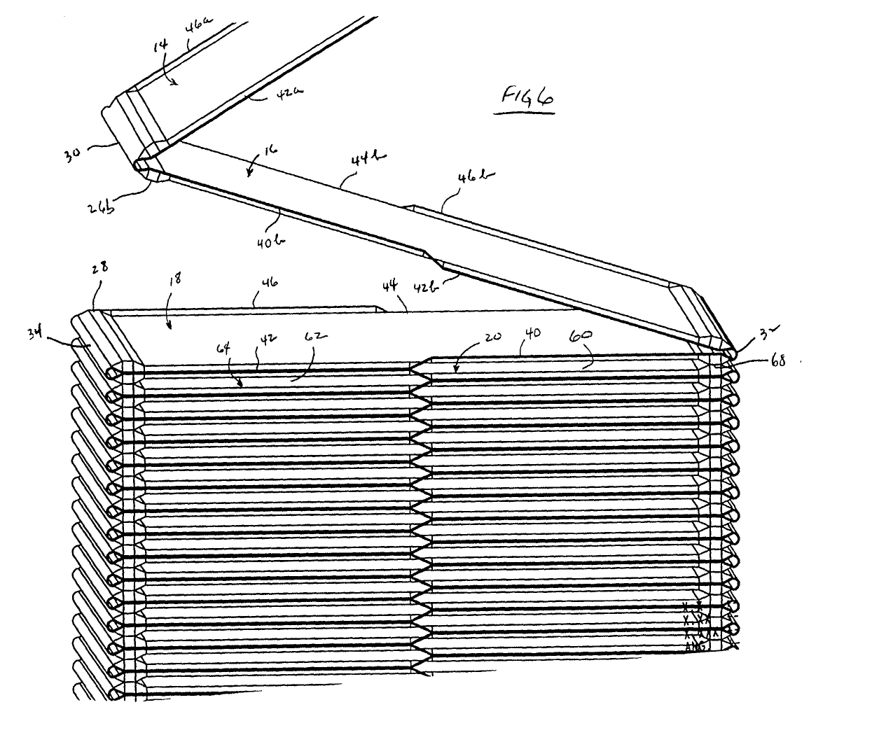

Referring to the latitudinal sides 28 and 26a surrounding the hinge 34, FIG. 4, it is seen that there are raised borders for the purpose of spacing adjacent panels from one another. This can be seen by way of example between the two panels 18, 20, FIG. 6. It can also now be observed by referring to FIG. 5 that the hinges alternate in the direction of folding from counterclockwise to clockwise to counterclockwise, etc. When the elongated strip is fully folded as shown in FIG. 7, two sets of fluid passages are formed. This is clearly shown in FIG. 6 where there is formed a first set of fluid passages, exemplified by the passage 60 formed between the panels 18 and 20, and a second set of fluid passages, exemplified by the passage 62 formed between the panel 20 and its adjacent panel 64. A passage identical to the passage 62 is also formed between the panels 16 and 18 whereas an identical passage to the passage 60 is formed between the panels 14 and 16. The two types of passages alternate between adjacent pairs of panels where one panel of the adjacent pairs is common to both pairs. Thus, the two pairs of panels 14, 16 and 16, 18 have the panel 16 in common. It is also noted that because of the alternating design, the set of passages like the passage 60 is open on the right side of the stacked panels when viewed from the front (FIG. 5) and is open on the right side when viewed from the rear (FIG. 6). Stated another way, the passages cross the panels when moving in a direction generally perpendicular to the longitudinal axis 12 of the strip. In a similar but opposite manner the other set of passages like the passage 62 also cross the panels. Nevertheless, most of the flows in the passages are such that it can be said that the core produced is of the counterflow variety.

It has already been disclosed that alternate portions of the longitudinal sides of the panels are closed and open. Referring now to the latitudinal sides, they are closed. For example, each of the hinges 30, 32, 34 connect adjacent panels as a solid integral piece. Further, between hinges a closure is formed by abutting raised latitudinal sides, such as the sides 26b, 28, FIGS. 5 and 6. In a similar manner a closure or seal 68, FIG. 6, is formed along the latitudinal sides of the panels 18 and 20.

When the elongated strip is fully folded as shown in FIG. 7, two sets of fluid flow passages are formed which alternate along the stack as exemplified by the fluid flow passages 60, 62. The passages are formed between alternate pairs of panels and by the structure of the individual panels and related hinges. Seals or closures are formed by abutting panels to keep the two sets of fluid passages separate. Thus, a fluid flow entering from the front, right side through the passage 60 is separated from another fluid flow entering from the rear, left side through the passage 62. This latter fluid flow will exit from the left, front side of the stacked panels. The flow passages are sealed because the hinges are solid material and the contacting portions of opposite latitudinal sides may be pressed together to prevent leakage. Or, an adhesive may be used to seal the contacting portions or heat may be used to cause bonding of these portions. The flow passages are further separated by the panels themselves. It is readily understood that if opposing fluid flows are at different temperatures, heat transfer will take place across each panel from the flowing higher temperature fluid to the flowing lower temperature fluid. It is to be noted that abutment between panels may also be made by projecting borders of one panel and mating recess borders of another panel where the two are nested. This also will form a closure.

Referring to FIG. 8, the folded strip of material 10 in the form of a core is placed within a simply constructed four piece heat exchanger housing comprising a lower housing member 70, a housing cover 72, and two trapezoidal partitions 74, 76. The partitions are provided to engage housing partitions 78, 80 respectively to maintain separated fluid flows in the housing. For example, an inlet as exemplified by the arrow 82 may be formed with a mating outlet, exemplified by the arrow 84. This flow can use the first set of passages, such as the passage 60. In a like manner, an inlet, exemplified by the arrow 86, is mated with an outlet, as exemplified by the arrow 88. This flow can use the second set of passages, such as the passage 62. It is to be noted that fluid flows may also be in generally the same direction. That is, both flows may move from left to right in the heat exchanger shown in FIG. 8.

The elongated strip is formed of a synthetic resin material, such as PVC film having a starting thickness of about 0.12 to about 0.18 inches. As explained in International Application No. PCT/GB98/03368 and incorporated herein by reference, the elongated strip of material may be thermoformed in an assembly line fashion to achieve the structural detail described for the panels and hinges above. Each panel emerges with a panel length, parallel to the latitudinal sides of the strip of between 1 and 3 feet and a panel width, parallel to the longitudinal sides of the strip, of between 1 and 2 feet. It is contemplated that the space between stacked panels is within the range of about 0.200 to 0.800 inches. Each stack of folded panels may be approximately 7 inches tall although it is to be understood that a stack may be made higher or lower as a function of the desired heat transfer. The same is true of the dimensions of the panels. These may also change depending upon the heat transfer characteristics desired. The manufacturing process will be described in more detail below.

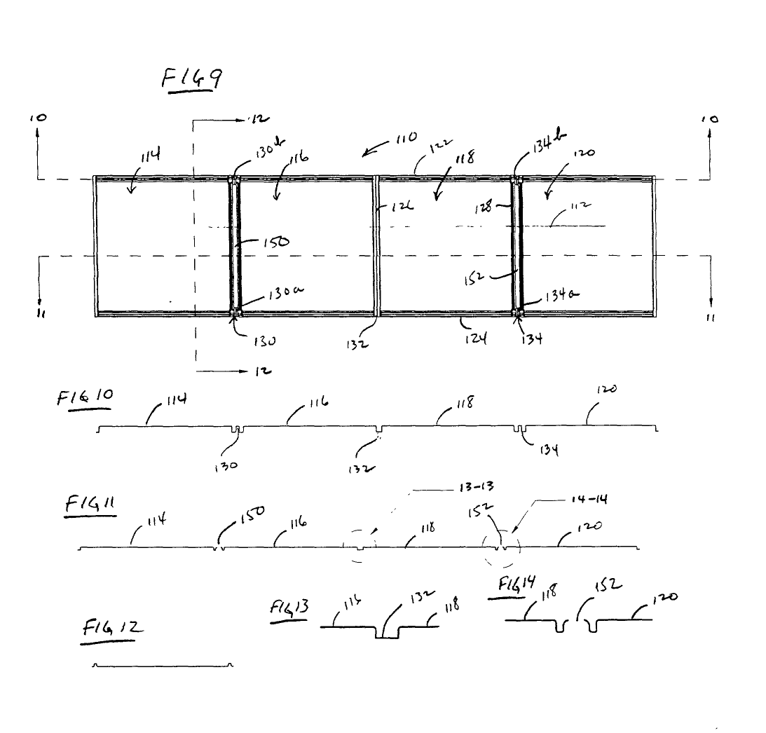

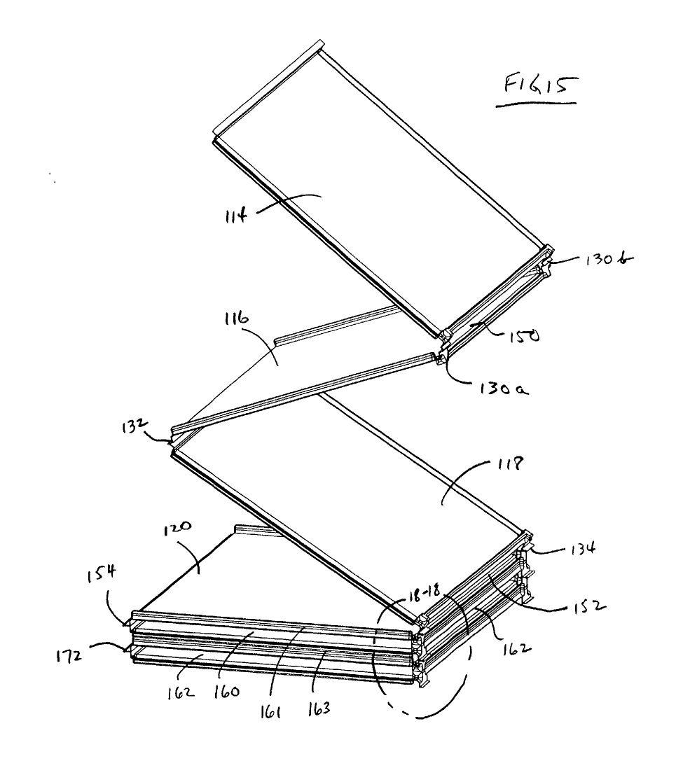

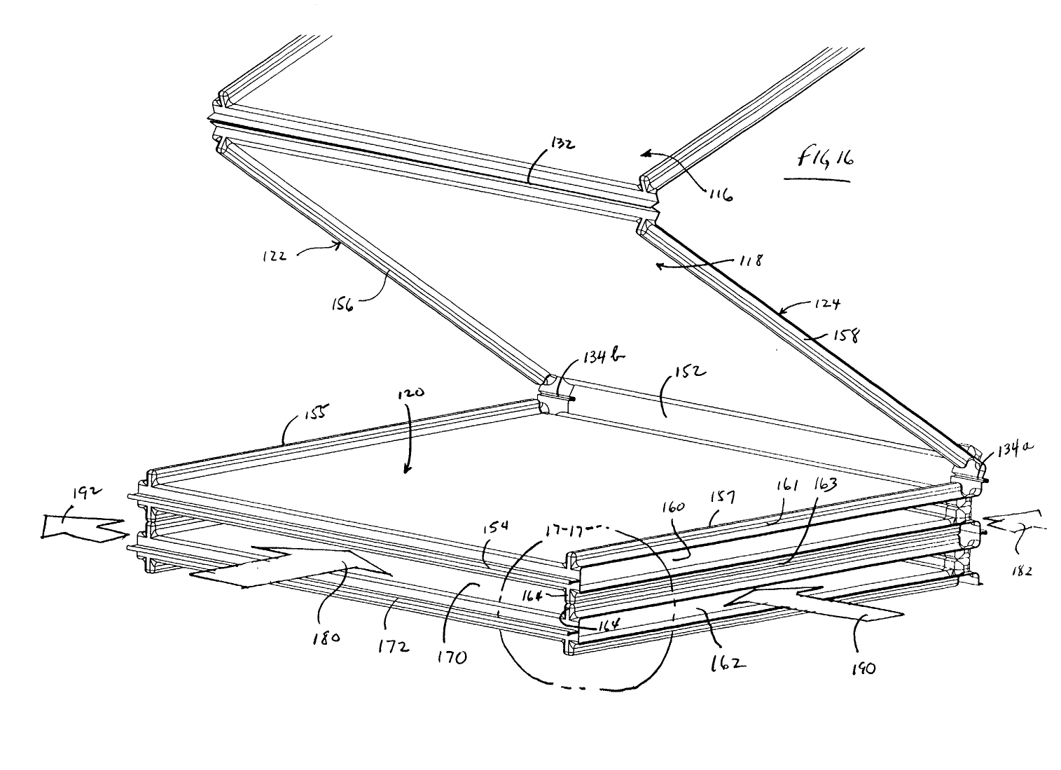

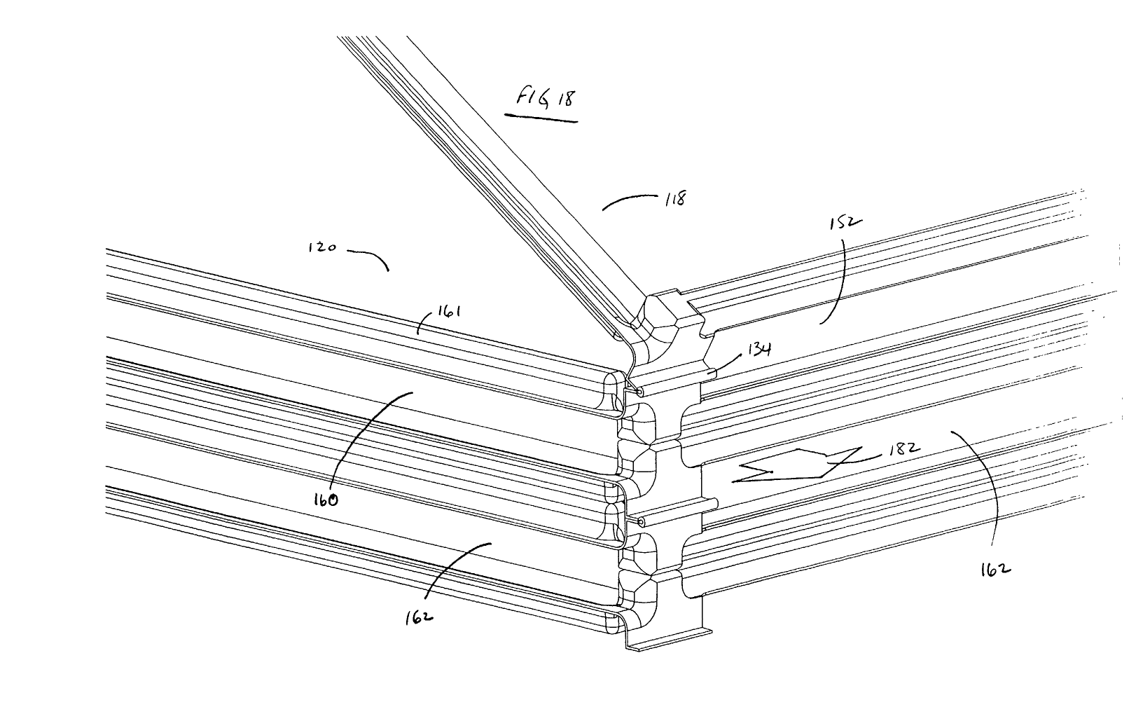

The simplicity and versatility of the present invention is shown by reference to FIGS. 9-18. There is illustrated another embodiment of a heat exchanger core which is similar to the embodiment illustrated in FIGS. 1-8 except that the second embodiment is for a cross-flow heat exchanger rather than a counterflow heat exchanger. There is illustrated a portion of an elongated strip 110 of synthetic resin material having a longitudinal axis 112. The elongated strip is formed into a series of connected or integral panels 114, 116, 118, 120. Each of the panels includes longitudinal sides and latitudinal sides, such as the longitudinal sides 122, 124 and latitudinal sides 126, 128 of the panel 118. Hinges 130, 132, 134 are formed integral with the panels and are positioned between panels to allow the strip to be alternately folded in an accordion fashion. The longitudinal and latitudinal sides have raised borders so that when folded, each panel is spaced from an adjacent panel whereby fluid flow passages between panels are created.

The most striking difference between the heat exchanger core embodiment shown in FIG. 1 and that shown in FIG. 9 is that the core in FIG. 9 has a region of every second hinge which is mostly open. When the elongated strip is folded, this opening forms an inlet or outlet for a fluid flow passage. Also, longitudinal sides of the panels either form a closure or an opening. In this manner, two series or sets of fluid flow passages are provided, the passages being at right angles to each other. One set of passages conducts flows parallel to the longitudinal axis 112 whereas the other set of passages conducts flows perpendicular to the first mentioned set and to the longitudinal axis.

Referring to FIGS. 9-16 in more detail, the openings between the panels are seen in more detail. For example, between the panel 114 and the panel 116 the hinge 130 includes a forward portion 130a and a rearward portion 130b separated by an opening 150. . The hinge 132 extends across the strip of material without any opening. The hinge 134 is also divided between a forward portion 134a, a rearward portion 134b and a central opening 152. Following the open hinge 134 is a closed hinge 154 which is identical to the hinge 132. In this fashion, closed and open hinges alternate with each other.

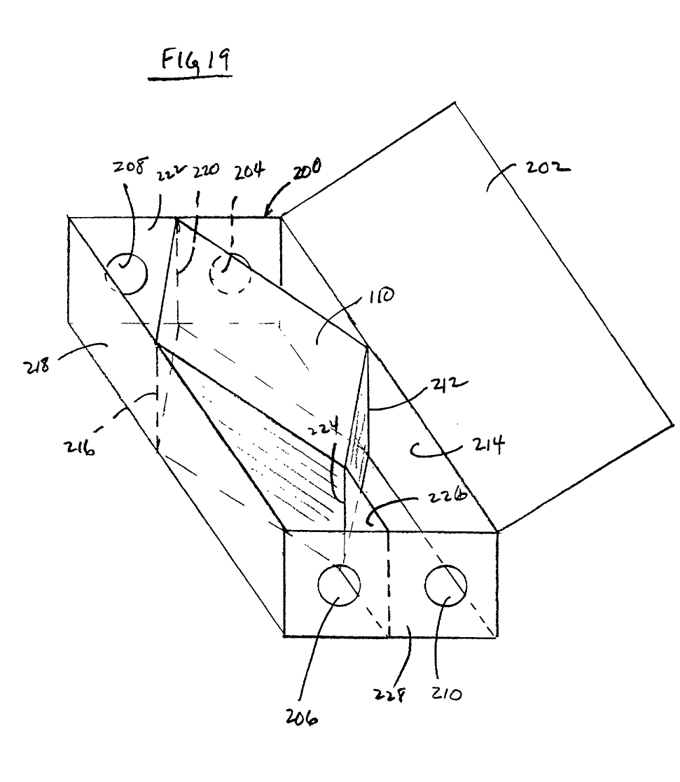

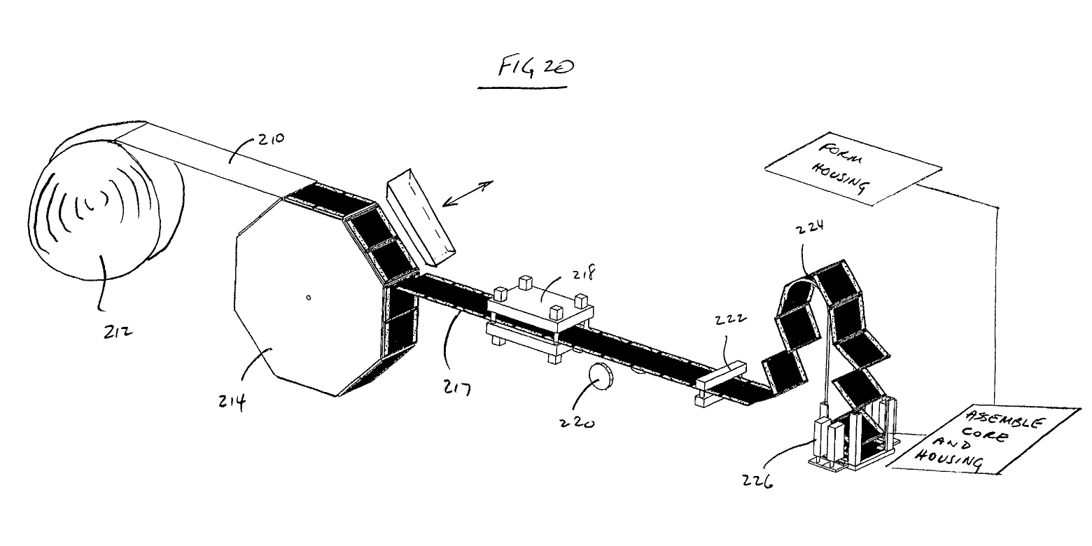

The panel 118 includes raised or projecting borders 156, 158, FIG. 16, along the upper and lower longitudinal sides 122, 124. The longitudinal sides of the adjacent panel 120 also include projecting borders 155, 157. When the projecting borders 155, 157 of the panel 120 engage or abut the projecting borders 156, 158 of the panel 118 closures are formed longitudinally. However, between the adjacent pair of panels 116, 118, the longitudinal sides do not have raised or abutting borders and thus openings is formed. Referring now to FIGS. 17 and 18, the openings 160, 162 in the longitudinal sides between panels are shown alternating with closed or sealed longitudinal sides 161, 163 caused by the raised or projecting borders, such as the raised borders 164, 166. The latitudinal sides have openings, such as the opening 170, alternating with closed hinges, such as the hinges 154, 172. As with the earlier embodiment, nesting elements of two panels may also be used to close sides of panels to fluid flow.

The cross flow may best be seen by reference to FIGS. 16-18 where a fluid flow passage having the opening 170, parallel to the longitudinal axis, has an inlet, depicted by an inlet arrow 180, and an outlet, depicted by an outlet arrow 182. A fluid flow passage having the opening 162 includes an inlet, depicted by the inlet arrow 190, and an outlet, depicted by the outlet arrow 192, FIG. 16.

Referring to FIG. 19, there is illustrated the folded stacked strip 110 forming a core. The core is positioned in a heat exchanger housing 200 having a cover 202, a first inlet 204, a first outlet 206, a second inlet 208 and a second outlet 210. One corner 212 of the core is sealed against a wall 214 of the housing, an opposing corner 216 of the core is sealed to an opposite wall 218, a third corner 220 of the core is sealed to a third wall 222 and a fourth corner 224 of the core is connected to a partition 226 which is sealed to a fourth wall 228. This arrangement also allows for oppositely directed fluid flows if desired.

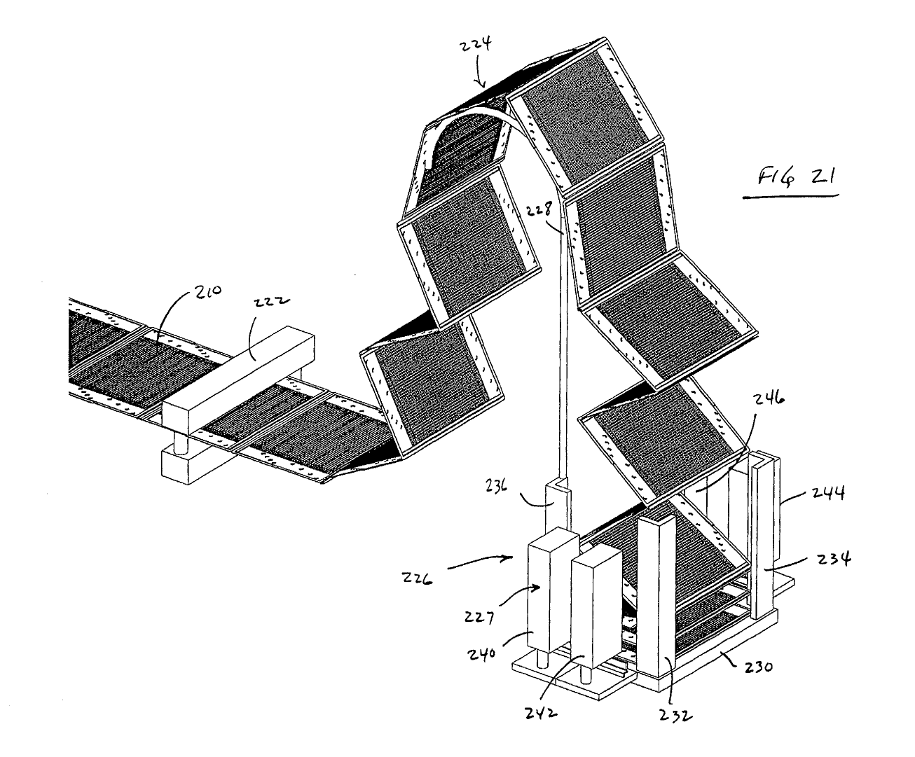

The simplicity and economical advantages achieved with the present invention may best be understood by referring to FIG. 20 which illustrates the process of forming the heat exchanger cores. The process starts with an elongated strip of synthetic resin material 210 formed into a roll 212. The roll is unwound in a continuous fashion at any suitable rate. The strip of material engages a drum 214 where it is heated and where pressure may be applied in the form of a plug 216 against the drum (mold). The heat and pressure thermoforms a repeated pattern on the strip in the form of a series of panels separated by the integral hinges. The strip is then cooled in the region 217 before moving to a trimming station where a trim die 218 removes excess material. Next the panels pass a counter station where a counter 220 measures a predetermined number of panels. Typically the number of panels measured will be equal to one plus the number of independent fluid flow paths needed to form a heat exchanger core having the desired heat transfer characteristics. After the predetermined number of panels are passed, a signal is sent to a cutter 222 at a cutting station and the strip of material is severed. The series of panels next moves to a folding station 224. The folding station may include a bonding station 226 with a bonding mechanism 227, FIG. 21, for dispensing an adhesive or for heat sealing selected portions.

The forming operation at the drum forms the hinges with a predisposition to fold in alternate directions, accordion style. The folding station 224, FIG. 21, includes a pair of spaced upsidedown J-shaped guides of which only one guide 228 is illustrated. When the strips of formed material are lifted from the horizontal position to pass over the guides, the hinges begin to assume the accordion fold. On the downward side of the guides, the self-folding is completed. The folded panels are guided to the bonding station 226 formed by a base 230 and four L-shaped corner members 232, 234, 236 (only three corner members are shown). The corner members help align the accordion folded panels so that the panels are properly arranged in a generally compact fashion parallel to each other. Movable bonding heads 240, 242, 244, 246 are arranged about the folded panels to bond selective portions of the panels together. For example, for a counterflow core, portions of the panel sides parallel to the longitudinal axis of the strip of material are bonded as are the sides perpendicular to the longitudinal axis which are opposite a hinge.

Bonding may be accomplished by the application of an adhesive; or, thermal bonding devices, such as ultrasonic or RF equipment may be used. The purpose of the bonding, as explained above, is to form two sets of fluid flow passages where the passages alternate between sets. The passages may also be formed simply by compressing the resulting folded stack of panels or constraining the core so that adjacent panels have abutting borders.

In addition to the core, heat exchanger housings are formed, such as by thermoforming and the appropriate heat exchanger core is inserted. See for example, FIGS. 8 and 19. The housing is then closed or sealed and the resulting heat exchanger may then be inserted into a heat management system.

It may now be appreciated that the core and housing forming process is relatively simple and reliable and uses known forming techniques. Assembly of the core and then the core into the housing are also simple and economical. Further, the core may be removed and cleaned easily and thereafter reassembled. In a like fashion, the core may be easily removed, disposed of and replaced.

In operation, the process starts with a roll of PVC material which is heated and formed. The forming may take place around the drum which acts as a mold in conjunction with a reciprocating plug. Other methods may be used to form the design of the panels and hinges onto the strip of material. The formed strip is then cooled before proceeding to a trimming station. The strip is then measured and cut to predetermined lengths. Thereafter the strip proceeds to the folding station where the preformed hinges fold the strip accordion style into a core. There may be a bonding station with movable bonding mechanisms that seal selected side portions to form the two sets of fluid flow paths formed in the core. As mentioned earlier, bonding may be accomplished by an adhesive or portions of the core may be thermally bonded. In the meantime, a heat exchanger housing is formed and the last step includes the assembly of the core and the housing. This process is more economical than previous processes because there is no need to rotate panels through 90 or 180 degrees. There is also a savings since there is less sealing required.

The specification describes in detail an embodiment of the present invention. Other modifications and variations will, under the doctrine of equivalents, come within the scope of the appended claims. For example, whether the process includes bonding with heat or adhesive or whether the core is simply placed in a housing is considered equivalent processes. Also, the method of forming the panels and hinges on the strip of plastic may be done in any suitable way known to those skilled in the art. These will all be considered equivalent processes. A change of material or the particular designs of the panels and hinges are also considered equivalent to the claimed processes. Still other alternatives will also be equivalent as will processes brought on by new technologies. There is no desire or intention here to limit in any way the application of the doctrine of equivalents.

The heat exchangers described here may be used in electronic equipment enclosures used by the telecommunications industry and in energy recovery ventilators used in the HVAC industry. Because of the economical approach to manufacture and assembly, the heat exchangers of the present invention may also find uses in other fields and industries.

1. A process for making a heat exchanger core comprising the steps of:
providing a strip of synthetic resin material having a longitudinal axis;
forming in said material a continuous series of panels, said panels being separated from one another by an integral hinge, each panel having first and second sides disposed generally parallel to the longitudinal axis of said strip of material and third and fourth oppositely disposed sides generally perpendicular to the longitudinal axis of said strip of material, said panels also having raised portions for spacing one panel from adjacent panels when said strip of material is folded;
cutting said material in predetermined locations in a direction generally perpendicular to the longitudinal axis of said strip of material after said forming step; and
folding said material along each hinge in an accordion fashion wherein two separate sets of fluid flow passages are formed, the passages of one set alternating with the passages of the other set.

2. A process as claimed in claim 1 wherein:
said forming step includes the steps of heating, applying pressure and cooling the strip of material.

3. A process as claimed in claim 2 including the step of:
trimming said strip of material after said forming step.

4. A process as claimed in claim 3 including the step of:
measuring predetermined lengths of said strip of material.

5. A process as claimed in claim 2 including the step of:
selectively abutting sides of said panels with adjacent panels.

6. A process as claimed in claim 5 wherein:
said abutting step includes abutting portions of sides of adjacent panels, which sides are parallel to the longitudinal axis of said strip.

7. A process as claimed in claim 6 wherein:
said abutting step includes abutting portions of sides of adjacent panels which are perpendicular to the longitudinal axis of the strip of material.

8. A process as claimed in claim 2 wherein:
the forming step includes forming an opening in every second hinge.

9. A process as claimed in claim 7 including the step of:
trimming said strip of material.

10. A process as claimed in claim 9 including the step of:
measuring said strip of material.

11. A process as claimed in claim 7 including the steps of:
trimming said strip of material; and
measuring said strip of material.

12. A process for making and assembling a heat exchanger comprising the steps of:
providing a strip of synthetic resin material having a longitudinal axis;
providing a synthetic resin housing;
forming in said strip of material a continuous series of panels, said panels being separated from one another by an integral hinge, each panel having first and second sides disposed generally parallel to the longitudinal axis of said strip of material and third and fourth oppositely disposed sides generally perpendicular to the longitudinal axis of said strip of material, said panels also having raised portions for spacing one panel from adjacent panels when said strip of material is folded;
cutting said material in predetermined locations and in a direction generally perpendicular to the longitudinal axis of said strip of material after said forming step;
folding said material along each hinge in an accordion fashion wherein two separate sets of fluid flow passages are formed, the passages of one set alternating with the passages of the other set; and
enclosing said folded strip of material in said housing.

13. A process as claimed in claim 12 wherein:
said forming step includes the steps of heating, applying pressure and cooling the strip of material.

14. A process as claimed in claim 13 including the step of:
trimming said strip of material after said forming step.

15. A process as claimed in claim 14 including the step of:
measuring predetermined lengths of said strip of material.

16. A process as claimed in claim 14 including the step of:
selectively abutting sides of said panels with adjacent panels.

17. A process as claimed in claim 16 wherein:
the forming step includes forming an opening in every second hinge.
